(19) United States
(12) Patent Application Publication
(10) Pub. No.: US 2011/0203382 A1
(43) Pub. Date: Aug. 25, 2011

(54) GAUGE FOR PRESSURE MEASURING DEVICE

(75) Inventors: Gi Gong Kim, Gyeonggi-do (KR); Hyung Min Kim, Seoul (KR); Sung Sub Oh, Seoul (KR)

(73) Assignee: TPC MECHATRONICS CORP., Seoul (KR)

(21) Appl. No.: 12/673,007

(22) PCT Filed: Oct. 31, 2007
(86) PCT No.: PCT/KR07/05479

§ 371 Date: Feb. 11, 2010

(30) Foreign Application Priority Data
Aug. 14, 2007 (KR) 20-2007-0013480

(51) Int. Cl. G01L 7/04; G01L 7/00

(52) U.S. Cl. 73/732; 73/700

(57) ABSTRACT

A gauge for a pressure measuring device, the gauge includes a gauge body disposed at the front of the pressure measuring device. The gauge body having a graduated circle, a range display window formed on a graduated circle and a pointer to indicate a scale on the graduated circle corresponding to a measured pressure by the pressure measuring device. A base plate disposed at the rear of the gauge main body and viewed through the range display window, and first and second gauge fans rotatably disposed on the base plate to set the pressure range of an upper limit value and a lower limit value on the graduated circle.

### TECHNICAL FIELD

The present invention relates to a gauge for a pressure measuring device, and more particularly, to a gauge for a pressure measuring device to constantly keep a change of an output load thereof, in which a limit value to limit the pressure of a gas is displayed on the pressure measuring device.

### BACKGROUND ART

In general, a conventional regulator, as an example of a pressure measuring device, is of a type in which a safety valve is actuated to discharge a gas to the outside when the gas of excessive pressure is input to the regulator due to carelessness of a user.

FIG. 1 is a schematic view of a conventional regulator.

As shown in FIG. 1, the regulator 10 includes a connector 12 connected to a pipe 30, a controller (not shown) for controlling the amount of a fluid flowing through the pipe 20, and a gauge 20 on which the amount of the fluid is displayed. The gauge 20 includes a main body 21, a graduated circle 22, and a pointer 23 for indicating the scale of the graduated circle corresponding to a value (i.e., the amount of a fluid), which is measured in a measuring unit (not shown) of the regulator 10.

In the gauge 20 of the conventional regulator 10, when the pointer 23 is deviated from a reference value of the scale (i.e., a desired location of the scale of the amount of a fluid), which is desired to a worker, that is, when the amount of a fluid is smaller than or greater than the reference value, the worker could not notice this situation easily. In order to solve this problem to some extent, the worker temporarily attaches a transparent color sticker 24 to a glass plate of the gauge 20, which is a portion corresponding to a reference range, on the spot or paints the portion with a specific color.

However, this method is problematic in that the painted color or the color of the color sticker 24 is faded as time goes by, or the color sticker falls off from the glass plate due to weaken adhesive force. Accordingly, if the color sticker is used, it is inconvenient for a worker to replace the color sticker with a new on periodically.

### DISCLOSURE OF INVENTION

### Technical Problem

It is, therefore, an object of the present invention to provide a gauge for a pressure measuring device in which the pressure range of an upper limit value and a lower limit value can be identified by any worker and range setting is convenient.

### Technical Solution

In accordance with an embodiment of the present invention, there is provided a gauge for a pressure measuring device, which includes:

a gauge body disposed at the front of the pressure measuring device, the gauge body having a graduated circle, a range display window formed on a graduated circle and a pointer to indicate a scale on the graduated circle corresponding to a measured pressure by the pressure measuring device;

a base plate disposed at the rear of the gauge main body and viewed through the range display window; and

first and second gauge fans rotatably disposed on the base plate to set the pressure range of an upper limit value and a lower limit value on the graduated circle.

### ADVANTAGEOUS EFFECTS

As described above, according to the present invention, the gauge for the pressure measuring device is advantageous in that the pressure range of an upper limit value and a lower limit value required in a work site can be identified by every worker and task convenience can be improved since range setting is facilitated.

### BRIEF DESCRIPTION OF THE DRAWINGS

The above and other objects and features of the present invention will become apparent from the following description of preferred embodiments given in conjunction with the accompanying drawings, in which:

FIG. 1 is a view illustrating an example of a conventional regulator;

FIG. 2 is a disassembled perspective view of a gauge for a pressure measurement device in accordance with an embodiment of the present invention;

FIGS. 3 and 4 illustrate the operation of the gauge for the pressure measurement device in accordance with an embodiment of the present invention; and

FIGS. 5 and 6 illustrate the use of the gauge for a pressure measurement device in accordance with an embodiment of the present invention.

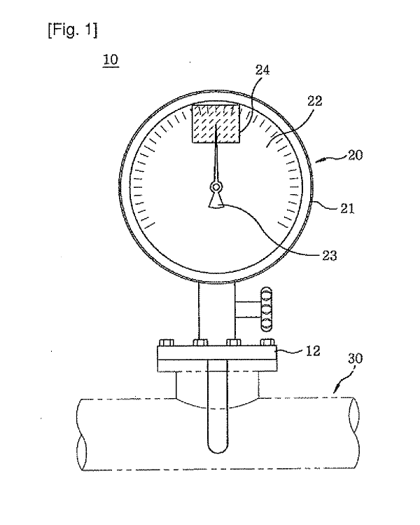

### BEST MODE FOR CARRYING OUT THE INVENTION

Hereinafter, embodiments of the present invention will be described in detail with reference to the accompanying drawings so that they can be readily implemented by those skilled in the art.

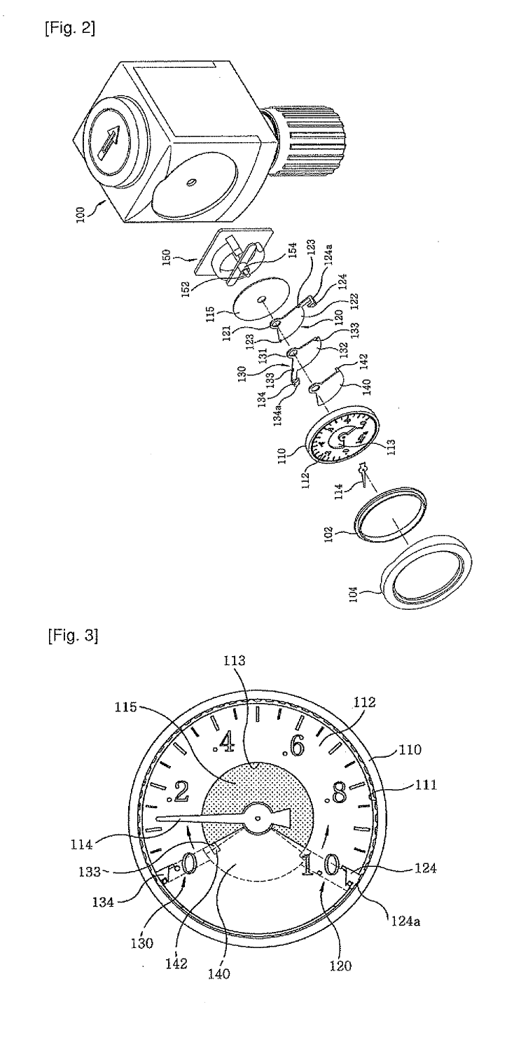

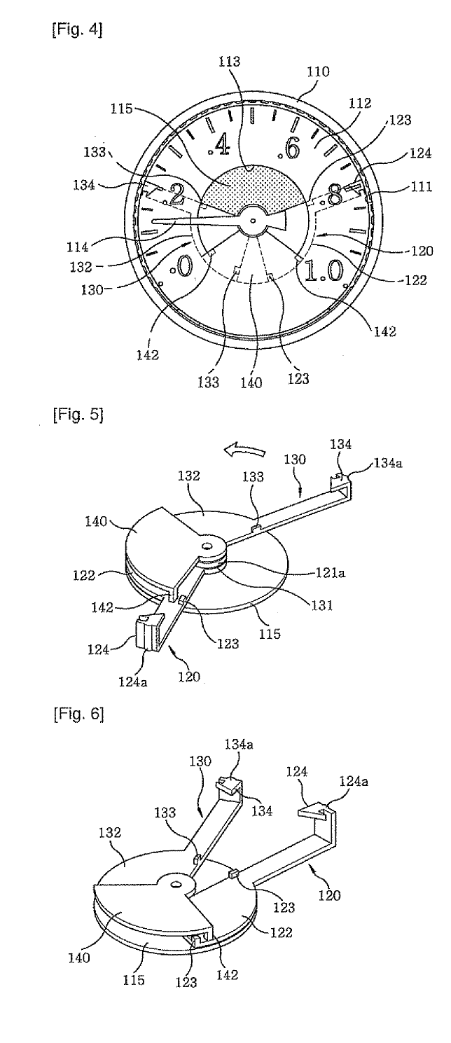

FIG. 2 is a disassembled perspective view of a gauge for a pressure measurement device in accordance with an embodiment of the present invention, and FIGS. 3 and 4 illustrate the operation of the gauge for the pressure measurement device shown in FIG. 2.

As shown in FIG. 2 the gauge for the pressure measurement device generally includes a gauge body 110, a base plate 115 disposed in the gauge main body 110, first and second gauge fans 120 and 130 being rotated on the base plate 115, and a third gauge fan 140 to limit the range of the first and second gauge fans 120 and 130. The gauge is configured to allow everyone to easily know the pressure range of an upper limit value and a lower limit value.

The gauge body 110 has preferably a circular shape, and is inserted into the front surface of a pressure measuring device 100 and fixedly installed thereto through a gauge cover 102 and a cover ring 104, which can be detached from and attached to the pressure measuring device 100.

The gauge body 110 includes a fan-shaped range display window 113, a graduated circle 112, and a pointer 114 to indicate a scale corresponding to a value (the amount of a fluid), which is measured in a measuring unit (not shown) of the pressure measuring device 100. The fan-shaped range display window 113, the graduated circle 112, and the pointer 114 are rotatably coupled to a fixed shaft 152 at the center of the gauge body 110.

The range display window 113 is formed at a central portion of the graduated circle 112 in which the scale is displayed along the cylindrical direction.

The third gauge fan 140, the first and second gauge fans 120 and 130, and the base plate 115 are sequentially disposed at the rear of the graduated circle 112. The base plate 115 has a disk shape and is partially viewed through the range display window 113 with a predetermined color.

The first and second gauge fans 120 and 130 have colors different from that of the base plate 115 in contrast. Further, the first and second gauge fans 120 and 130 are disposed opposite to each other and rotated about the center of the base plate 115. The first and second gauge fans 120 and 130 are configured to adjust the area of the base plate 115 viewed on the range display window 113 and also indicate a pressure range corresponding to an upper limit value and a lower limit value through the scale of the graduated circle 112.

Furthermore, as best shown in FIGS. 5 and 6, the first and second gauge fans 120 and 130 include rotating units 121 and 131, circular arc plates 122 and 132, and limit indicators 124 and 134. The rotating units 121 and 131 have through holes formed at their centers so that they are fixedly supported by the fixed unit 154 of a Bourdon tube 150. The circular arc plates 122 and 132 extend from the rotating units 121 and 131 having a size similar to that of a circular art of the base plate 115, respectively. The limit indicators 124 and 134 integrally horizontally extend from one sides of the circular arc plates 122 and 132 and have an upwardly curved portion by 90° at their ends and arrow tips inwardly formed at the curved portion, respectively.

The circular arc plates 122 and 132 have stoppers 123 and 133 projected from both sides thereof, respectively. The stoppers 123 of the first gauge fan 120 are disposed in plural numbers opposite to the end of the radius of both sides of the circular arc plate 122. The stoppers 133 of the second gauge fan 130 are disposed in plural numbers in an opposite manner so that they are close to the center compared with the locations of the stoppers 123 of the first gauge fan 120. That is, the stoppers 133 of the second gauge fan 130 may be located inwardly toward the center than the stoppers 123 of the first gauge fan 120. This is for the purpose of preventing interference when the third gauge fan 140 is rotated.

In the limit indicators 124 and 134 of the first and second gauge fans 120 and 130, the arrow tips are opposite to each other, and are projected toward the graduated circle 112 to indicate the scale. Further, projections 124a and 134a are formed on outer lateral sides of the limit indicators 124 and 134. The projections 124a and 134a are engaged with irregularity grooves 111 formed on the inner surface of the gauge body 110 so that they can be prevented from moving due to vibration and shock.

The third gauge fan 140 is rotatably disposed on the first and second gauge fans 120 and 130, and functions to limit a minimum range and a maximum range of an upper limit value and a lower limit value achieved by the first and second gauge fans 120 and 130. The third gauge fan 140 may have the same color as those of the first and second gauge fans 120 and 130, and is formed with a circular arc surface similar to the base plate 115 in radius. Further, the third gauge fan 140 has latch jaws 142, which are curved downwardly at right angles toward the upper surface of the first and second gauge fans 120 and 130, formed on both sides of the circular arc surface.

One of the latch jaws 142 is formed at a location that is brought in contact with the stoppers 123 of the first gauge fan 120, and the other of the latch jaws 142 is formed at a location that is brought in contact with the stoppers 133 of the second gauge fan 130.

Meanwhile, referring back to FIG. 2, the pointer 114 is coupled to one end of the fixed shaft 152 that is rotatably projected from the main body of the Bourdon tube 150 disposed within the pressure measuring device 100. The fixed unit 154 of a cylindrical shape is projected toward one side of the Bourdon tube 150 outside the fixed shaft 152. The fixed unit 154 fixes the graduated circle 112, the first, second and third gauge fans 120, 130, and 140, and the base plate 115 at the center.

An operation of the gauge for the pressure measuring device constructed above according to the present invention will be described below.

In order for every worker to identify a pressure range of an upper limit value and a lower limit value required in a work site, the gauge cover 102 and the cover ring 104 are separated from the pressure measuring device 100, and the limit indicators 124 and/or 134 of the first gauge fan 120 and/or the second gauge fan 130 is rotated toward a desired scale so that it reaches the pressure range. As shown in FIG. 3, at a maximum pressure range in a range between 0 and 10, a large part of the base plate 115 having a specific color is viewed on the range display window 113. However, as shown in FIG. 4, the first and second gauge fans 120 and 130 having different colors are viewed on the range display window 113 when the first and second gauge fans 120 and 130 are rotated along arrows shown in FIG. 3 for a range setting. Thus, the range display window 113 having an adjusted pressure range, e.g. in a range between 2 and 8, can be identified easily. The values of the pressure range are the scales of the graduated circle 112, which is indicated by the limit indicators 124 and 134, and can be easily perceived to everyone.

The limit indicators 124 and 134 located within the pressure range are not easily moved by vibration or shock without forced rotation of a worker since the projections 124a and 134a are located in the irregularity grooves 111 of the gauge main body 110.

The operational relationship of the first and second gauge fans 120 and 130 and the third gauge fan 140 is described in more detail with reference to FIGS. 5 and 6. Referring to FIG. 5, if the first and second gauge fans 120 and 130 are rotated so that they are maximally widen from each other, the first and second gauge fans 120 and 130 do not further rotated in the circular arc plates 122 and 132 by the interaction with the stoppers 123 and 133 adjacent to the limit indicators 124 and 134 because the stoppers 123 and 133 are brought in contact with the latch jaw 142 of the third gauge fan 140. This state becomes the maximum pressure range.

At this state, since the stoppers 123 and 133 of the first and second gauge fans 120 and 130 are formed at difference locations, the stoppers 123 are not interfered by the latch jaws 142 of the third gauge fan 140 when the first gauge fan 120 is rotated.

Furthermore, in the case of a minimum pressure range shown in FIG. 6, if the first and second gauge fans 120 and 130 are rotated so that they come close, the stoppers 123 and 133 on the circular arc plates 122 and 132 are brought in contact with each other while attracting the latch jaws 142 of the third gauge fan 140 to prevent from being further rotated. Accordingly, the third gauge fan 140 serves to limit the minimum pressure range achieved by the first and second gauge fans 120 and 130.

Once the pressure range is set as described above, the gauge cover 102 and the cover ring 104 are mounted in the pressure measuring device 100. However, there needs to change the pressure range, the above operation for the range setting is then performed as described above. Therefore, the gauge for the pressure measuring device according to the present invention enables the range of the scale required for pressure to be easily recognized, and enables a pressure range to be set easily.

While the invention has been shown and described with respect to the preferred embodiments, it will be understood by those skilled in the art that various changes and modifications may be made without departing from the scope of the invention as defined in the following claims.

1. A gauge for a pressure measuring device, the gauge comprising:
a gauge body disposed at the front of the pressure measuring device, the gauge body having a graduated circle, a range display window opened on the graduated circle and a pointer to indicate a scale on the graduated circle corresponding to a measured pressure by the pressure measuring device;
a base plate disposed at the rear of the gauge main body and viewed through the range display window; and
first and second gauge fans rotatably disposed on the base plate to set the pressure range of an upper limit value and a lower limit value on the graduated circle.

2. The gauge of claim 1, wherein each of the first and second gauge fans includes:
a rotating unit having a through hole formed therein;
a circular arc plate extending from the rotating unit and being rotated on the base plate; and
a limit indicator integrally horizontally extending from one side of the circular arc plate and having an upwardly curved portion at its end and arrow tips inwardly fanned at the curved portion.

3. The gauge of claim 2, wherein the circular arc plate has stoppers formed on both sides of a circular arc of the circular arc plate,
the stoppers of the first gauge fan being disposed in plural numbers opposite to an end of a radius of both ends of the circular arc plate, and
the stoppers of the second gauge fan being disposed in plural numbers in an opposite way so that they are closer to the center than the stoppers of the first gauge fan.

4. The gauge of claim 2, wherein each of the first and second gauge fans has projections that are formed on outer lateral sides of the limit indicators thereof, respectively, and wherein the gauge body has irregularity grooves formed on an inner cylindrical surface thereof so that the projections are engaged with the irregularity grooves in order to prevent the movement thereof.

5. The gauge of claim 1, further comprising a third gauge fan rotatably disposed on the first and second gauge fans and configured to limit minimum and maximum pressure ranges of the upper limit value and the lower limit value.

6. The gauge of claim 5, wherein the third gauge fan includes latch jaws, which are curved downwardly toward the first and second gauge fans, formed on both sides of the circular arc surface.

7. The gauge of claim 6, wherein one of the latch jaws of the third gauge fan is formed at a location that is brought in contact with the stopper of the first gauge fan, and the other of the latch jaws of the third gauge fan is formed at a location that is brought in contact with the stopper of the second gauge fan.

8. The gauge of claim 1, further comprising: a Bourdon tube disposed within in the pressure measuring device;
a fixed shaft rotatably projected from the Bourdon tube, on which the pointer is coupled; and
a fixed unit of a cylindrical shape projected from one side of the Bourdon tube outside the fixed shaft, the fixed unit fixing the graduated circle, the first, second, and third gauge fans, and the base plate at a center.

9. The gauge of claim 1, wherein the range display window is of a shape of a fan.

10. The gauge of claim 1, first and second gauge fans are viewed through the range display window.
